(19) United States
(12) Patent Application Publication
(10) Pub. No.: US 2006/0093149 A1
(43) Pub. Date: May 4, 2006

(54) Certified deployment of applications on terminals

(75) Inventors: Kaishen Zhu, Shanghai (CN); Maciej Michal Kubiczek, Kunshan (CN); Victor Jerry Crosetti, Kunshan (CN)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Shera International Ltd.

(21) Appl. No.: 11/260,631

(22) Filed: Oct. 27, 2005

Related U.S. Application Data
(60) Provisional application No. 60/623,648, filed on Oct. 30, 2004.

(51) Int. Cl. H04L 9/00

(52) U.S. Cl. 380/277

(57) ABSTRACT

Embodiments of the present invention relate to secure deployment of software applications on transaction terminals using keys and certificates. In one embodiment, a method for electronically certifying an application for installation at a transaction terminal is accomplished at a terminal key management server by receiving an application along with a request to certify the application, comparing the application to one or more terminal constraints, issuing a certificate that corresponds to the application, digitally signing the certificate, and making the digitally signed certificate and the encrypted application available to the transaction terminal. In another embodiment, a method for validating a certified application for installation on the transaction terminal is accomplished by receiving a notification, downloading an encrypted version of the application, downloading a digitally signed certificate, decrypting the application, verifying the digital signature of the certificate, and installing the application on the transaction terminal.

### CROSS-REFERENCE TO RELATED APPLICATIONS

This United States Patent Application claims the benefit of U.S. Provisional Application No. 60/623,648, filed on Oct. 30, 2004, and titled “Method and Method for Providing Certificated Deployment of Applications on Terminals,” which is hereby incorporated by reference.

### BACKGROUND OF THE INVENTION

1. The Field of the Invention

The present invention relates generally to systems and methods for providing certified deployment of applications on terminals. More particularly, embodiments of the invention relate to secure deployment of software applications on transaction terminals using keys and certificates.

### THE RELEVANT TECHNOLOGY

Transaction terminal are electronic computer systems that allow customers to perform monetary transactions securely over a secure network. More so than with other types of computer systems, the sensitive nature of the financial data that is stored and transferred between transaction terminals requires a high level of data security. Transaction terminals, such as automated teller machines (ATMs) and point-of-sale devices (POSs), typically use a combination of hardware and software security mechanisms in order to keep data secure. The owners of transaction terminals are generally very careful to allow only those software applications which conform to specific security standards to run on their transaction terminals.

Before a software application is installed onto a transaction terminal, the owner of the transaction terminal will generally decide upon some resource constraints and security constraints within which the software application must operate in order to be acceptable for the transaction terminal. Manually determining whether the software application fits within the hardware and security constraints can be costly and time consuming for the transaction terminal owner. In addition, establishing secure means of communication between a software application and back end systems, owned by either the owner of the application or the owner of the transaction terminal, can also be very costly and time consuming where establishing secure mean of communication requires that a technician have physical access to the transaction terminal.

Also, when the owner of a software application wishes to install the application or application data on a transaction terminal, the owner of the transaction terminal must grant the owner of the software application access to the terminal. Because of security concerns, owners of transaction terminals are sometimes hesitant to grant remote access, such as over a network, to owners of software applications for fear that allowing remote access to any third parties would compromise the security of the transaction terminal. Therefore, the installation of applications or application data is often accomplished by sending a trusted human technician to the physical location of the transaction terminal with the software application or application data stored on some form of storage medium such as a magnetic disk, compact disk, or smart card. The trusted technician is then given physical access to a physical storage medium drive of the transaction terminal that is capable of reading the information from the storage medium in order to install the software application or application data on the transaction terminal.

Sometimes more than one transaction terminal will need to be updated with a new software application or update to an existing software application simultaneously. Sending a technician to each transaction terminal that requires the new software application or updated software application can be very time consuming and costly for the application owner. Similarly, this method of sending a live technician to each transaction terminal can be inconvenient for the transaction terminal owner who must arrange for a time and place to accommodate the installation work by the technician. Furthermore, the security of the transaction terminal or software application can be compromised by the live technician, which often induces application and transaction terminal owners to send more than one technician to each installation for added security, which increases the costs involved with the installation of each application.

### BRIEF SUMMARY OF THE INVENTION

The principles of the present invention relate to systems and methods for providing certified deployment of applications on terminals. The systems and methods relate to secure deployment of software applications on transaction terminals using keys and certificates.

In one embodiment, a method for electronically certifying an application for installation at a transaction terminal at a terminal key management server includes receiving an application along with a request to certify the application; comparing the application to one or more terminal constraints to determine whether the application complies with the one or more terminal constraints, where the one or more terminal constraints require at a minimum that the application will function properly in the operating environment on the transaction terminal; if the application complies with the one or more terminal constraints, issuing a certificate that corresponds to the application and certifies that the application complies with the one or more terminal constraints; digitally signing the certificate using an application management private key, the application management private key being part of a public/private key pair, the corresponding application management public key being accessible to the transaction terminal; encrypting the application using a terminal master public key, the terminal master public key being part of a public/private key pair, the corresponding terminal master private key being accessible to the transaction terminal; and making the digitally signed certificate and the encrypted application available to the transaction terminal.

In another embodiment, a method for validating a certified application for installation on the transaction terminal at a transaction terminal includes receiving a notification that a certified application is ready to be installed; in response to receiving the notification, downloading an encrypted version of the application at the transaction terminal, the encrypted version of the application being encrypted with a terminal master public key, the terminal master public key being part of a public/private key pair, the corresponding terminal master private key being accessible to the transaction terminal; downloading a digitally signed certificate that corresponds to the encrypted version of the application, the digitally signed certificate certifying that the application complies with one or more terminal constraints, the certificate being digitally signed using an application management private key, the application management private key being part of a public/private key pair, the corresponding application management public key being accessible to the transaction terminal; decrypting the encrypted version of the application using the terminal master private key to reveal an unencrypted version of the application; verifying the digital signature of the certificate using the application management public key to determine whether the corresponding application has been validly certified as complying with one or more terminal constraints of the transaction terminal; and if the application has been validly certified, installing the application on the transaction terminal.

In yet another embodiment, a method for securely providing an application key to a transaction terminal at a security access module delivery server includes sending a request to a hardware security module at the transaction terminal to load an application key onto the transaction terminal, the hardware security module being embedded in a processor at the transaction terminal and configured to securely store application keys, where the request is encrypted using a terminal master public key, the terminal master public key being part of a public/private key pair, the corresponding terminal master private key being accessible to the transaction terminal; receiving a response from the hardware security module granting permission to load the application key onto the terminal, where the response is digitally signed using the terminal master private key; in response to receiving the response granting permission, generating an application key to be used by the hardware security module when performing an encryption operation on data associated with the application corresponding to the application key; and transmitting the application key to a secure key storage in the hardware security module of the transaction terminal, where the application key is encrypted using the terminal master public key.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable computing system that may implement features of the present invention;

FIG. 2A illustrates a networked environment in accordance with the principles of the present invention;

FIG. 2B illustrates one aspect of an example architecture according to the present invention;

FIG. 2C illustrates another aspect of an example architecture according to the present invention;

FIG. 3 illustrates a flow chart of an example method for implementing features present invention;

FIG. 4 illustrates a flow chart of another example method for implementing features of the present invention; and

FIG. 5 illustrates a flow chart of another example method for implementing features of the present invention.

### DETAILED DESCRIPTION OF EXAMPLE EMBODIMENTS

The principles of the present invention relate to secure deployment of software applications on transaction terminals using keys and certificates. In one embodiment, a method for electronically certifying an application for installation at a transaction terminal at a terminal key management server includes receiving an application along with a request to certify the application; comparing the application to one or more terminal constraints to determine whether the application complies with the one or more terminal constraints, where the one or more terminal constraints require at a minimum that the application will function properly in the operating environment on the transaction terminal; if the application complies with the one or more terminal constraints, issuing a certificate that corresponds to the application and certifies that the application complies with the one or more terminal constraints; digitally signing the certificate using an application management private key, the application management private key being part of a public/private key pair, the corresponding application management public key being accessible to the transaction terminal; encrypting the application using a terminal master public key, the terminal master public key being part of a public/private key pair, the corresponding terminal master private key being accessible to the transaction terminal; and making the digitally signed certificate and the encrypted application available to the transaction terminal.

In another embodiment, a method for validating a certified application for installation on the transaction terminal at a transaction terminal includes receiving a notification that a certified application is ready to be installed; in response to receiving the notification, downloading an encrypted version of the application at the transaction terminal, the encrypted version of the application being encrypted with a terminal master public key, the terminal master public key being part of a public/private key pair, the corresponding terminal master private key being accessible to the transaction terminal; downloading a digitally signed certificate that corresponds to the encrypted version of the application, the digitally signed certificate certifying that the application complies with one or more terminal constraints, the certificate being digitally signed using an application management private key, the application management private key being part of a public/private key pair, the corresponding application management public key being accessible to the transaction terminal; decrypting the encrypted version of the application using the terminal master private key to reveal an unencrypted version of the application; verifying the digital signature of the certificate using the application management public key to determine whether the corresponding application has been validly certified as complying with one or more terminal constraints of the transaction terminal; and if the application has been validly certified, installing the application on the transaction terminal.

In yet another embodiment, a method for securely providing an application key to a transaction terminal at a security access module delivery server includes sending a request to a hardware security module at the transaction terminal to load an application key onto the transaction terminal, the hardware security module being embedded in a processor at the transaction terminal and configured to securely store application keys, where the request is encrypted using a terminal master public key, the terminal master public key being part of a public/private key pair, the corresponding terminal master private key being accessible to the transaction terminal; receiving a response from the hardware security module granting permission to load the application key onto the terminal, where the response is digitally signed using the terminal master private key; in response to receiving the response granting permission, generating an application key to be used by the hardware security module when performing an encryption operation on data associated with the application corresponding to the application key; and transmitting the application key to a secure key storage in the hardware security module of the transaction terminal, where the application key is encrypted using the terminal master public key.

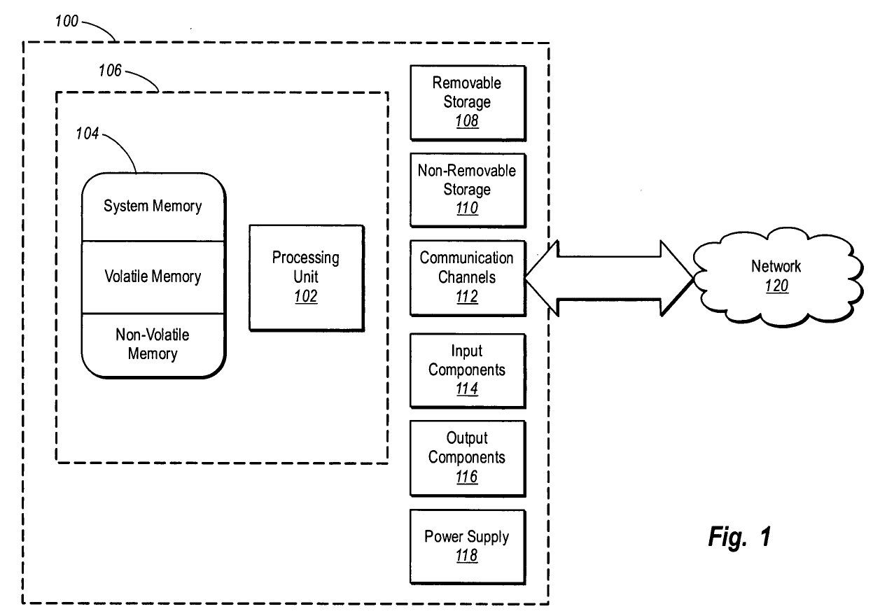

In the description and following claims, the invention is described with reference to acts and symbolic representations of operations that are performed by one or more computers. In the description and following claims, the terms “server” and “terminal” both refer to a computer. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware. FIG. 1 shows a schematic diagram of an example computer architecture usable for these devices, namely servers and terminals.

For descriptive purposes, the architecture portrayed is only one example of a suitable environment and is not intended to suggest any limitation as to the scope of use or functionality of the invention. Neither should the computing systems be interpreted as having any dependency or requirement relating to any one or combination of components illustrated in FIG. 1.

The invention can be practiced with numerous other general-purpose or special-purpose computing or communications environments or configurations. Examples of well known computing systems, environments, and configurations suitable for use with the invention include, but are not limited to, mobile telephones, pocket computers, personal computers, servers, transaction terminals, multiprocessor systems, microprocessor-based systems, minicomputers, mainframe computers, and distributed computing environments that include any of the above systems or devices.

In its most basic configuration, a computing system 100 typically includes at least one processing unit 102 and memory 104. The memory 104 may be volatile (such as RAM), non-volatile (such as ROM, flash memory, etc.), or some combination of the two. This most basic configuration is illustrated in FIG. 1 by the dashed line 106.

The storage media devices may have additional features and functionality. For example, they may include additional storage (removable and non-removable) including, but not limited to, PCMCIA cards, magnetic and optical disks, magnetic tape, and integrated circuit cards (or ICC cards, also known as smart cards). Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, integrated circuit cards, and any other media that can be used to store the desired information and that can be accessed by the computing system.

Within this description and the following claims, the terms “module” or “component” refer to software objects or routines that execute on the computing system. The different components, modules, engines, and services described herein may be implemented as objects or processes that execute on the computing system (e.g., as separate threads). While the system and methods described herein are preferably implemented in software, implementations in software and hardware or hardware are also possible and contemplated.

Computing system 100 may also contain communication channels 112 that allow the host to communicate with other systems and devices over, for example, network 120. Communication channels 112 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

The computing system 100 may also have input components 114 such as a keyboard, mouse, pen, a voice-input component, a touch-input device, a credit or debit card reader, an integrated circuit card reader (also known as a smart card reader), a currency acceptor, an envelope acceptor, and so forth. Output components 116 include screen displays, speakers, printer, etc., and rendering modules (often called “adapters”) for driving them. The computing system 100 has a power supply 118. All these components are well known in the art and need not be discussed at length here.

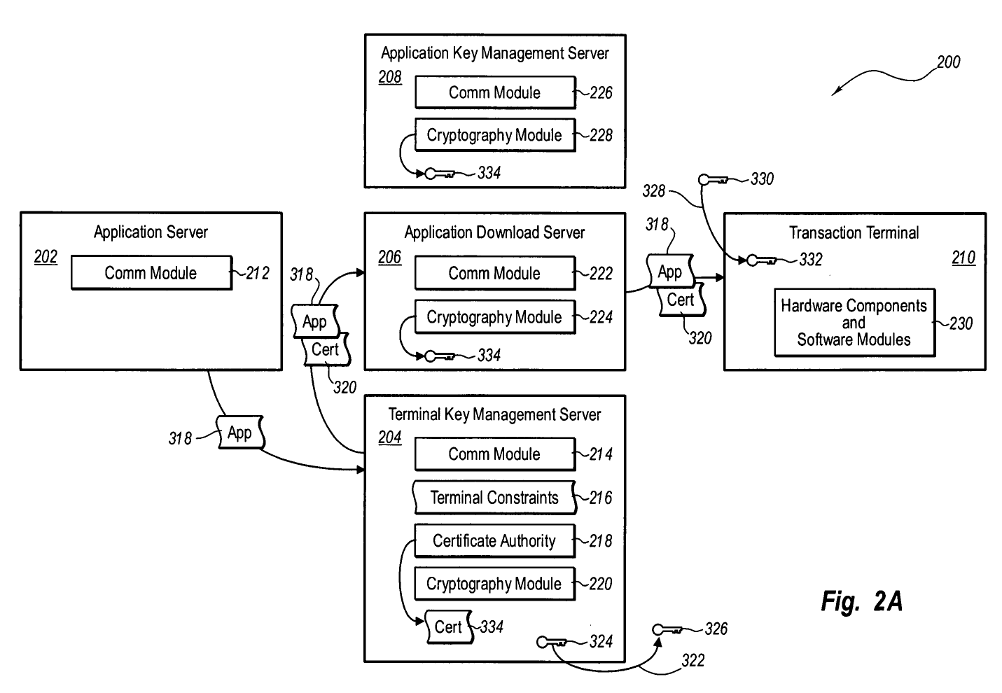

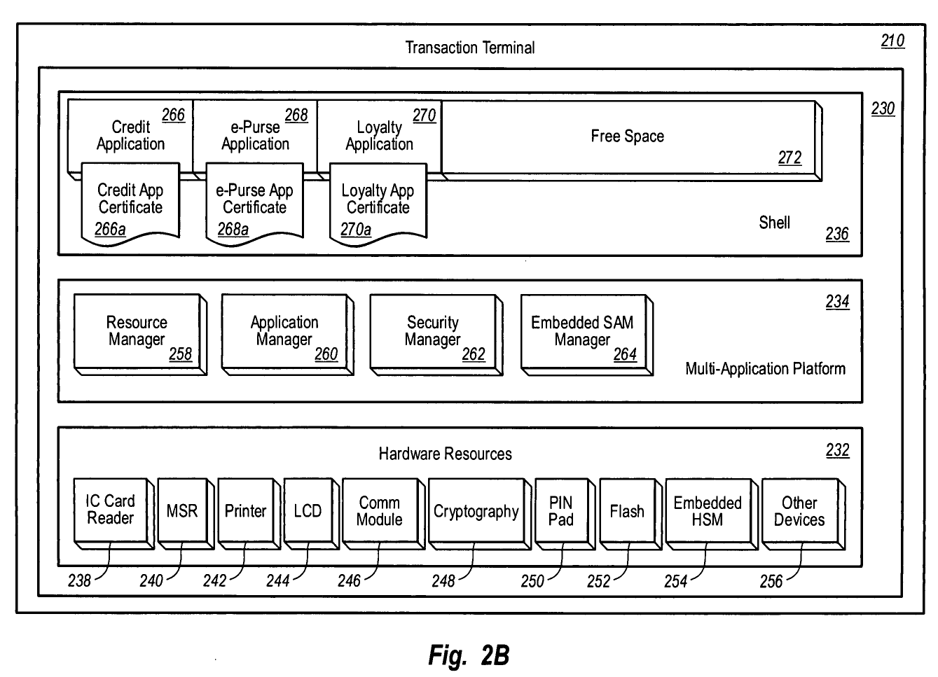

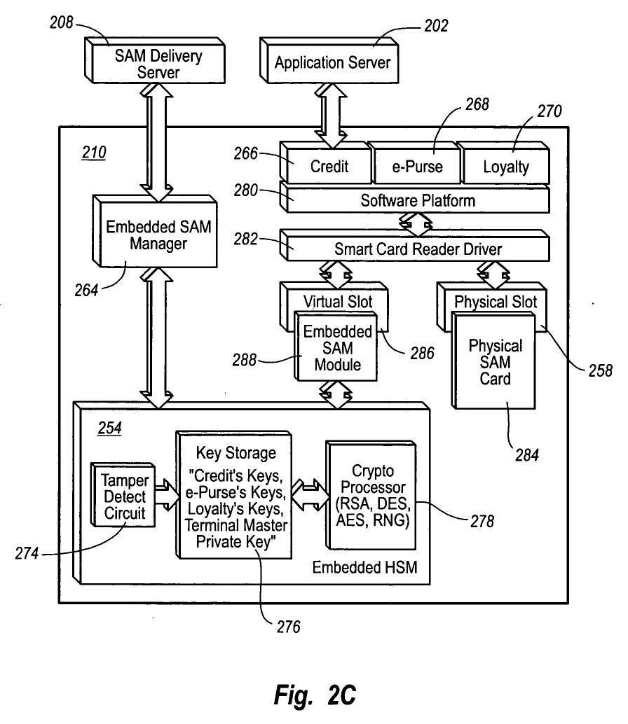

FIG. 2A illustrates a digitally networked environment 200 in accordance with the principles of the present invention. Digitally network environment 200 includes an Application Server 202 that is capable of being network connected to a Terminal Key Management Server 204, an Application Download Server 206, an Application Key Management Server 208, and Transaction Terminal 210, each of which are network connectable to one another. For example, each of Application Server 202, Terminal Key Management Server 204, Application Download Server 206, Application Key Management Server 208, and Transaction Terminal 210 is capable of being networked to each other. The digitally networked environment 200 allows software applications to be securely deployed to Transaction Terminal 210 without any human intervention. This lack of human intervention makes the secure deployment of software applications less costly to the owner of Transaction Terminal 210. The digitally networked environment 200 also allows unused resources of Transaction Terminal 210 to be advertised to third party software application vendors. This advertisement ability enables the owner of Transaction Terminal 210 to rent or sell application and storage space on Transaction Terminal 210 in a flexible and secure manner. The digitally networked environment 200 also allows the owners of software applications to send their software applications to Transaction Terminal 210 from their own backend servers, such as Application Server 202, and, once installed, the application can communicate securely with without these same backend servers.

In this description and in the following claims, a “server” is defined as any device or system that has a system memory, and at least one processor capable of executing instructions from system memory. Alternatively and in addition, the server may have any logic processing capability, even if implemented entirely in hardware. Accordingly, the Application Server 202, the Terminal Key Management Server 204, the Application Download Server 206, and the Application Key Management Server 208 may, but need not, be structured as described above in the discussion of the computing system 100. Similarly, in this description and in the following claims, a “transaction terminal” is defined as any device or system that has a system memory, and at least one processor capable of executing instructions from system memory, that is also capable of handling secure financial transactions. Accordingly, the Transaction Terminal 210 may, but need not, be structured as described above in the discussion of the computing system 100.

In this description and in the following claims, the use of the terms “encrypt,” “decrypt,” “digitally sign,” and “verify” in the context of a public/private key pair refers to actions performed on data stored in a digital format according to one or more public key cryptography algorithms such as, for example, RSA or ECC.

Application Server 202 is generally configured to send new software applications and software application updates for eventual installation on Transaction Terminal 210. Application Server 202 is also generally configured to send and receive application data that is associated with applications that have been installed on Transaction Terminal 210. Although digitally networked environment 200 depicts a single Application Server 202, Transaction Terminal 210 can be network connected with multiple application servers. Likewise, although digitally networked environment 200 depicts a single Transaction Terminal 210, Application Server 202 can be network connected with multiple transaction terminals.

Application Server 202 includes a Communication Module 212 that is configured to electronically send and receive applications, application data, and other electronic messages over a network connection. The applications sent by Communication Module 212 can be new software applications for Transaction Terminal 210, or updates to existing software applications already installed on Transaction Terminal 210. The application data send by Communication Module 212 can be data that is used by software applications that are installed on Transaction Terminal 210 and are associated with Application Server 202. The messages sent and received by Communication Module 212 relate to software applications associated with Application Server 202. These messages can include requests that applications be certified for installation at Transaction Terminal 210.

Terminal Key Management Server 204 is generally configured to generate public/private key pairs for use by Transaction Terminal 210. Terminal Key Management Server 204 is also generally configured to certify software applications for installation on Transaction Terminal 210. Although digitally networked environment 200 depicts a single Transaction Terminal 210 networked with Terminal Key Management Server 204, Terminal Key Management Server 204 can be network connected with multiple transaction terminals, and accordingly handle the key generation and software application certification for the multiple transaction terminals.

Terminal Key Management Server 204 includes a Communication Module 214 that is configured to electronically send and receive applications, application data, certificates, keys, and other electronic messages over a network connection. The application received and sent by Communication Module 214 can be new software applications or updates to existing software application for Transaction Terminal 210.

Terminal Key Management Server 204 also includes one or more Terminal Constraints 216 that specify constraints for applications that are to be installed on Transaction Terminal 210. The one or more Terminal Constraints 216 can be stored on Terminal Key Management Server 204, for example, as entries in a database or as an independent data file or independent data files. The one or more Terminal Constraints 216 can specify, for example, the maximum amount of disk space that an application and any associated application data can occupy, the maximum amount of memory that the application can use, the security priority of the application, the hardware that will be available to the application, and the maximum network bandwidth that the application can use. Similarly, the one or more Terminal Constraints 216 can specify the particular type of applications that can be installed on Transaction Terminal 210. For example, the one or more Terminal Constraints 216 can specify that only debit/credit type applications will be accepted on Transaction Terminal 210, or that only communication type applications will be accepted on Transaction Terminal 210. Likewise, the one or more Terminal Constraints 216 can also specify a minimum payment amount or commission per transaction amount to be paid to the owner of Transaction Terminal 210. The one or more Terminal Constraints 216 can also be custom tailored for specific applications or groups of applications. For example, the one or more Terminal Constraints 216 one application from one application owner can be allowed more disk space that another application from another application owner. The one or more Terminal Constraints 216, and all terminal constraints in this description and in the following claims, can therefore be customized at least according the desires of the owner of Transaction Terminal 210 or according to the desires of the owner of the transaction terminal to which the terminal constraints correspond.

Terminal Key Management Server 204 also includes a Certificate Authority module 218 that is capable of certifying application for installation on Transaction Terminal 210. Certificate Authority module 218 is also configured to issue certificates for applications that it certifies. The certificates issued by Certificate Authority module 218 can be X509 format certificate with terminal constraints encoded in the certificate. Terminal Key Management Server 204 also includes a Cryptography Module 220 that is capable of encrypting/decrypting and/or digitally signing/verifying applications and certificates. For example, Cryptography Module 220 might use RSA or ECC in order to encrypt/decrypt and/or digitally sign/verify applications and certificates.

Cryptography Module 220 of Terminal Key Management Server 204 is also capable of generating and storing certain keys that are used to encrypt/decrypt and/or digitally sign/verify applications and certificates. For example, in one embodiment of Terminal Key Management Server 204, Cryptography Module 220 can generate an “application management” public/private key pair 322. Application management private key 324 can be stored at Terminal Key Management Server 204 and kept private for use only by Terminal Key Management Server 204. Application management public key 326 can be made available for use by other servers or transaction terminals, such as Transaction Terminal 210. In this example, application management private key 324 can be used by the Cryptography Module 220 of Terminal Key Management Server 204 to digitally sign certificates that are generated by Certificate Authority module 218. Other servers or transaction terminals, such as Transaction Terminal 210, can then use application management public key 326 to verify that a given certificate was digitally signed by the Cryptography Module 220 of Terminal Key Management Server 204.

Cryptography Module 220 is also capable of using public keys to encrypt applications. For example, Transaction Terminal 210 can have a master public/private key pair known as the “terminal master” public/private key pair 328. Cryptography Module 220 can access terminal master public key 330 and use it to encrypt software applications. Transaction Terminal 210 can in turn store, and keep secret, terminal master private key 332, as discussed further below, and use it to decrypt the applications that were encrypted by Cryptography Module 220 using terminal master public key 330. In this manner, an application can be securely transferred from Terminal Key Management Server 204 to Transaction Terminal 210.

Application Download Server 206 is generally configured to receive new software applications or updates to existing software application, along with corresponding certificates facilitate the downloading of the applications and corresponding certificates by Transaction Terminal 210. Application Download Server 206 includes a Communication Module 222 that is configured to receive and send new software applications or updates to existing software and certificates for Transaction Terminal 210. Application Download Server 206 also includes a Cryptography Module 224 that is capable of encrypting/decrypting and/or digitally signing/verifying applications.

For example, at or near the same time that an application is sent by Application Server 202 to Terminal Key Management Server 204, the application can also be sent by Application Server 202 to Application Download Server 206. After Application Download Server 206 receives the application from Application Server 202, and later receives a digitally signed certificate for the application from Terminal Key Management Server 204, the Cryptography Module 224 of Application Download Server 206 can use terminal master public key 330, as discussed above, to encrypt the application. Then, Application Download Server 206 make the encrypted application, along with the corresponding digitally signed certificate, available to Transaction Terminal 210 for download. Thus, the Cryptography Module 224 of Application Download Server 206 can be used in lieu of the Cryptography Module 220 of Terminal Key Management Server 204 to encrypt applications before the applications are downloaded to Transaction Terminal 210.

Application Key Management Server 208 is generally configured to serve as a portal between Application Server 202 and Transaction Terminal 210. More specifically, Application Key Management Server 208 is configured to facilitate secure communication of application data and application keys and messages between Application Server 202 and Transaction Terminal 210. Application Key Management Server 208 includes a Communication Module 226 that is configured to send and receive application data, application keys, and application messages over a network connection. Application Key Management Server 208 also includes a Cryptography Module 228 that is capable of encrypting and/or digitally signing application data, application keys, and application messages.

Cryptography Module 228 of Application Key Management Server 208 is also capable of generating and storing certain keys that are used to encrypt/decrypt and/or digitally sign/verify application data and application messages. In one embodiment, Cryptography Module 228 can generate application public/private key pairs (not shown) for each of the applications that are installed on Transaction Terminal 210. The application public/private key pairs can be configured for one time use, such as session keys, or for ongoing use. The application public/private key pairs can be sent to the Transaction Terminal 210 and stored for use by the corresponding application installed on Transaction Terminal 21 0.

Cryptography Module 228 of Application Key Management Server 204 is also capable of using certain keys to encrypt and/or digitally sign application data, application keys, and application messages. As discussed above, Transaction Terminal 210 can utilize a master public/private key pair known as the “terminal master” public/private key pair 328. Cryptography Module 228 can store the terminal master public key 230 and use it to encrypt application messages, application keys, and application data, including keys generated at Application Key Management Server 208 that need to be securely transported to Transaction Terminal 210. Transaction Terminal 210 can store and keep secret terminal master private key 332, as discussed further below, and use it to decrypt the application data, application keys, and application messages that were encrypted by Cryptography Module 228 of Application Key Management Server 204 and/or use it to digitally sign application messages being sent to Application Key Management Server 204.

For example, Cryptography Module 228 can use terminal master public key 330 to encrypt an application public/private key pair generated for a specific application installed on Transaction Terminal 210 before the application public/private key pair is transported to Transaction Terminal 210. In this example, the application public/private key pair can be securely transported from Application Key Management Server 208 to Transaction Terminal 210. This secure transportation is accomplish through the encryption of the application public/private key pair at Application Key Management Server 208 using terminal master public key 330 and the decryption of the application public/private key pair at Transaction Terminal 210 using terminal master private key 332.

Transaction Terminal 210 is generally configured to handle secure financial transactions. Transaction Terminal 210 includes various hardware components and software modules 230. Turning now to FIG. 2B, an example of the various hardware components and software modules 230 of Transaction Terminal 210 of FIG. 2A are described in greater detail. The various hardware components and software modules 230 of Transaction Terminal 210 can be grouped into at least three basic levels: a Hardware Resources level 232, Multi-Application Platform level 234, and a Shell level 236.

The Hardware Resources level 232 includes an Integrated Circuit (IC) Card Reader (also known as a Smart Card Reader) 238, a Multi-Server Router (MSR) 240, a Printer 242, a Liquid Crystal Display (LCD) 244, a Communication Module 246, a Cryptography Component 248, a Personal Identification Number (PIN) Pad 250, Flash Memory 252, an Embedded Hardware Security (HSM) Module 254, and various other hardware devices 256.

The Multi-Application Platform level 234 includes several software modules. A Resource Manager module 258 is configured to receive an application certificate and make sure that there are sufficient resources, both hardware and software, available on the Transaction Terminal 210 to support the corresponding application according to the terminal constraints that are listed in the application certificate. An Application Manager module 260 is configured to install applications after they have been verified by Resource Manager module 258. Application Manager module 260 is also configured to create an application profile for each installed application which specifies the maximum amount of resources that the application can utilize, according to the terminal constraints included in the certificate that corresponds to the application. After an application has been installed on Transaction Terminal 210, a Security Manager module 262 monitors the application when it is running to make sure that the application does not utilize more resources than are allowed by the application profile of the application. An Embedded Security Access Module (SAM) Manager module 264 facilitates communication between Application Key Management Server 208 and Transaction Terminal 210, and will be discussed in greater detail below in connection with FIG. 2C.

The Shell level 236 includes several software applications and their corresponding certificates. Shell level 236 can be built on a platform that has been designed and specifically optimized for running applications that are written according to Global Platform Device/Small Terminal Interoperability Profile (GDP/STIP) standards. The applications installed on Shell level 236 can be STIP certified applications written in the JAVA programming language that have been translated into JEFF files. The applications installed on Shell level 236 include a Credit Application and Certificate 266, an e-Purse Application and Certificate 268, and a Loyalty Application and Certificate 270. Shell level 236 also includes Free Space 272 which represents resources on Transaction Terminal 210 that are available for use by additional software applications. Each software application installed on the Shell level 236 of Transaction Terminal 210 is configured to securely manipulate data, and in some cases, transfer application data between Application Server 202 and Transaction Terminal 210. The secure transfer of application data is discussed below in connection with FIG. 2C.

Turning now to FIG. 2C, and example of the Embedded HSM 254 and the Embedded SAM Manager module 264 of Transaction Terminal 210 of FIG. 2B are described in greater detail. One of the purposes of the Embedded HSM 254 is to remove the need for, and inherent data security risks of, using the IC Card reader 238 when installing software application keys at Transaction Terminal 210. As depicted in FIG. 2C, Embedded HSM 254 includes a Tamper Detect Circuit 274 configured to detect any attempt by an intruder to access the data stored in Embedded HSM 254 and automatically erase the data when any attempt to access the data is made. Embedded HSM 254 also includes a Key Storage 276 which is a battery backup SRAM configured to store keys, including the terminal master public/private key pair 328, as discussed above. Key Storage 276 is connected to Tamper Detect Circuit 274 and if an intruder attempts to access the keys stored in Key Storage 276, all the keys will immediately be erased. Embedded HSM 254 also includes a Crypto Processor 278 capable of encrypting and decrypting data that is sent to or from Embedded HSM 254. Some examples of the type of encryption that Crypto Processor 278 is capable of handling are RSA, DES/3DES, AES, MD5, ECC, SHAI and RNG. The Crypto Processor 278 is accelerated by hardware which enables it to perform encryption/decryption very quickly.

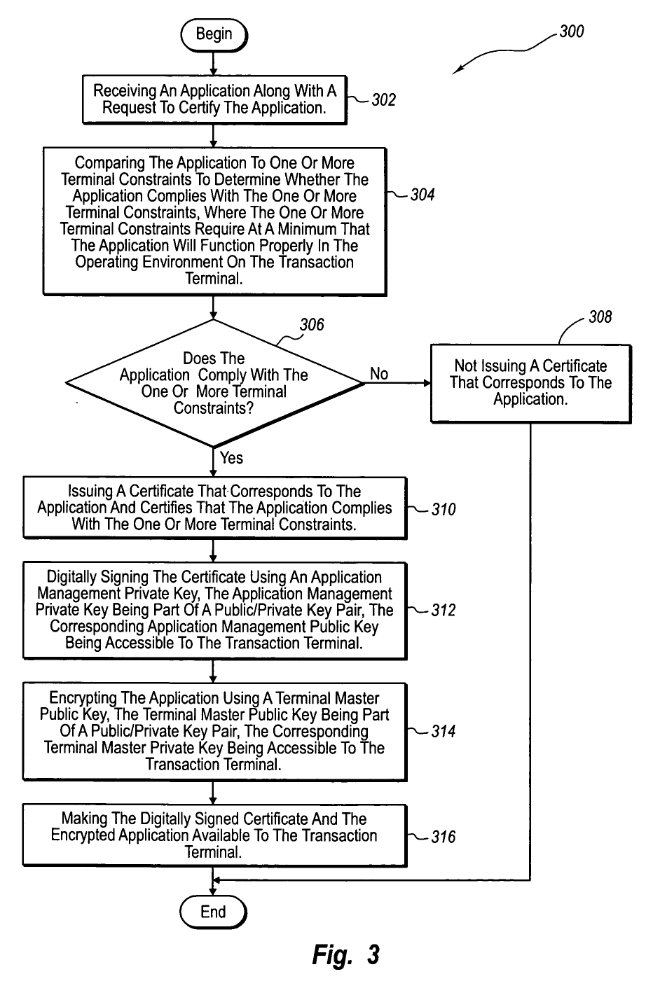

As illustrated in FIG. 3C, applications 266, 268, and 270 are configured to operate on a Software Platform 280 and communicate through a Smart Card Reader Driver 282 in order to access secure data. Secure data can be stored on a Physical Sam Card (also known as an Integrated Circuit Card or Smart Card) 284 which can be read by Physical Slot 258 (which corresponds to IC Card Reader 258 in FIG. 2B). However, in the present invention, applications 266, 268, and 270 are configured instead to access secure data in Embedded HSM 254 through Virtual Slot 286 and Embedded SAM Module 288. In practice, this can be accomplished by using a “slot ID.” When the Smart Card Reader Driver 282 is called by an application to access to secure data on a SAM Card, the application will pass a parameter called a “slot ID.” If the slot ID is in a specified range, the Smart Card Reader Driver 282 is configured to access Virtual Slot 2286 instead of Physical Slot 288. For example, slot ID's can range from 1-20, and the Smart Card Reader Driver 2282 can be configured communicate with an Embedded SAM Module 288 when the slot ID parameter passed by an application is in the range of 10-20.

The Embedded SAM Module 288 is a software module that is configured to simulate the functionality of a physical SAM card such as Physical SAM Card 284. For example, Embedded SAM Module 288 accepts application programming data unit (APDU) commands, calls corresponding functions in Embedded HSM 254 in order to execute the commands, and composes and sends APDU responses. An application that is running on Transaction Terminal 210 is not aware of whether secure data from a SAM is embedded or physical. It only knows the slot ID to call when it needs to access secure data on the the SAM, and the slot ID can be fixed in the program code of the application or it can be read from a configuration file.

The Embedded SAM Manager module 264 is a software module that is configured to manage the keys that are stored in the Key Storage 276 of the Embedded HSM 254. Embedded SAM Manager module 264 communicates with other servers, such as Application Key Management Server 208, in order to pass SAM data to and from Embedded HSM 254.

For example, Application Key Management Server 208 can send an encrypted message to Embedded SAM Manager module 264 with a request to load an application public/private key pair onto the Transaction Terminal 210. The encrypted message can have been encrypted using terminal master public key 330. Embedded SAM Manager module 264 would forward this encrypted request to Embedded HSM 254. The Crypto Processor 278 of Embedded HSM 254 would then decrypt the request using terminal master private key 332 that is stored in Key Storage 276. Embedded HSM 254 can then send Embedded SAM Manager module 264 a digitally signed response granting permission to load the application public/private key pair into the Key Storage 276 of Embedded HSM 254. The response can be digitally signed by Crypto Processor 278 using terminal master private key 332 stored in Key Storage 276. Embedded SAM Manager module 264 would then forward this response to Application Key Management Server 208, which would use terminal master public key 330 to verify that the response did indeed come from the Embedded HSM 254.

In response to receiving the response granting permission to load the application keys, the Application Key Management Server 208 can then generate an application public/private key pair for the application that can be used by the Embedded HSM 254 when performing an encryption operation on data associated with the application. The Application Key Management Server 208 can then decrypt the application public/private key pair using terminal master public key 330 and transmit the encrypted key pair to Embedded Sam Manager module 264, which will forward the encrypted key pair to Embedded HSM 254. Crypto Processor 278 will then decrypt the encrypted key pair using terminal master private key 332 and store the decrypted key pair in Key Storage 276 of Embedded HSM 254.

Turning now to FIG. 3, FIG. 3 depicts a method 300 for implementing features of the present invention. Method 300 is a method for electronically certifying an application for installation at a transaction terminal. Method 300 will be discussed with reference to the components and data in FIGS. 2A-2C.

Method 300 includes an act (302) of receiving an application along with a request to certify the application. For example, Transaction Key Management Server 204 can receive an application 318 along with a request to certify application 318. This application and this request are received from Application Server 202. The application can be any type of software application, including, for example, an STIP certified JAVA application that has been translated into a JEFF file or a piece of software that is part of the operating system of the Transaction Terminal 210. The term “application,” therefore, any type of software that can be installed on Transaction Terminal 210. The Communication Module 214 of Transaction Key Management Server 204 will receive application 318 and the request to certify application 318. This request can be motivated by an electronic advertisement from Transaction Terminal 210 of available resources on Transaction Terminal 210. For example, if Transaction Terminal has a certain amount of Free Space 272, as illustrated in FIG. 2B, in which additional applications can be installed and supported by Transaction Terminal 210, Transaction Terminal 210 may send an electronic advertisement to all application servers that are network connected to Transaction Terminal 210 offering to sell space on Transaction Terminal 210 for additional third party applications. The electronic advertisement can include information regarding the exact resources available on Transaction Terminal 210. Owners of application servers, such as the owner of Application Server 202, may then, in response to this electronic advertisement, send out compliant applications with the hopes that the applications will be certified and installed onto Transaction Terminal 210.

Method 300 also includes an act (304) of comparing the application to one or more terminal constraints to determine whether the application complies with the one or more terminal constraints, where the one or more terminal constraints require at a minimum that the application will function properly in the operating environment on the transaction terminal. For example, Certificate Authority module 218 can compare application 318 to the one or more Terminal Constraints 216. The one or more Terminal Constraints 216 can either be configured by the owner of Transaction Terminal 210, or can be negotiated between the owner of Transaction Terminal 210 and the owner of application 318, either before application 318 is sent to Terminal Key Management Server 204 or after application 318 is sent to Terminal Key Management Server 204. At a minimum, the one or more Terminal Constraints 216 must require that application 318 will function properly in the operating environment on Transaction Terminal 210. For example, if Transaction Terminal 210 has an operating environment that only supports applications that are written in the JAVA programming language that are Small Terminal Interoperability Profile (STIP) certified and have been translated into a JEFF file, then at a minimum, the one or more Terminal Constraints 216 will specify that any application must be written in JAVA, STIP certified, and translated into a JEFF file. The one or more Terminal Constraints 216 can also specify the maximum amount of hardware and software resources of Transaction Terminal 210 that an application can utilize, or the terminal constraints can specify the security priority that an application can be given once installed on Transaction Terminal 210. In this context, “security priority” defines the amount of access that an application will have to secure data and secure systems once the application is installed on Transaction Terminal 210. The one or more Terminal Constraints 216 stored in Terminal Constraints module 222 can remain constant for every application that is sent to Terminal Key Management Server 204, or can be changed from application to application.

Method 300 also includes a decision block (306) where the method branches one of two ways depending on whether the application complies with the one or more terminal constraints. If the application does not comply with the one or more terminal constraints (no at 306), then method 300 proceeds to an act (308) of not issuing a certificate for the application. For example, if Certificate Authority module 218 determines that application 318 does not comply with the one or more Terminal Constraints 216, Certificate Authority module 218 will not issue a certificate corresponding to application 318.

If, on the other hand, the application does comply with the one or more terminal constraints (yes at 306), then method 300 proceeds to an act (310) of issuing a certificate that corresponds to the application and certifies that the application complies with the one or more terminal constraints. For example, if Certificate Authority module 218 determines that application 318 does comply with the one or more Terminal Constraints 216, then Certificate Authority module 218 will issue a certificate 320 that corresponds to application 318. Certificate 320 certifies that application 318 complies with the one or more Terminal Constraints 216. Certificate 320 can contain a list of the one or more Terminal Constraints 216 with which application 318 is certified to be in compliance with.

Method 300 also includes an act (312) of digitally signing the certificate using an application management private key, the application management private key being part of a public/private key pair, the corresponding application management public key being accessible to the transaction terminal. For example, the Cryptography Module 220 can digitally sign certificate 320 using application management private key 324 which is part of a public/private key pair 322 and the corresponding application management public key 326 is accessible to Transaction Terminal 210.

Method 300 also includes an act (314) of encrypting the application using a terminal master public key, the terminal master public key being part of a public/private key pair, the corresponding terminal master private key being accessible to the transaction terminal. For example, the Cryptography Module 220 can encrypt application 318 using a master terminal public key 330 which is part of a public/private key pair 328 and the corresponding terminal master private key 332 is accessible to the Transaction Terminal 210.

Method 300 also includes an act (316) of making the digitally signed certificate and the encrypted application available to the transaction terminal. For example, Communication Module 214 can make the digitally signed certificate 320 and the encrypted application 318 available to Transaction Terminal 210. This can be accomplished by Communication Module 214 sending the digitally signed certificate 320 along with the encrypted application 318 to the Communication Module 222 of Application Download Server 206, which acts as a portal for applications and certificates to Transaction Terminal

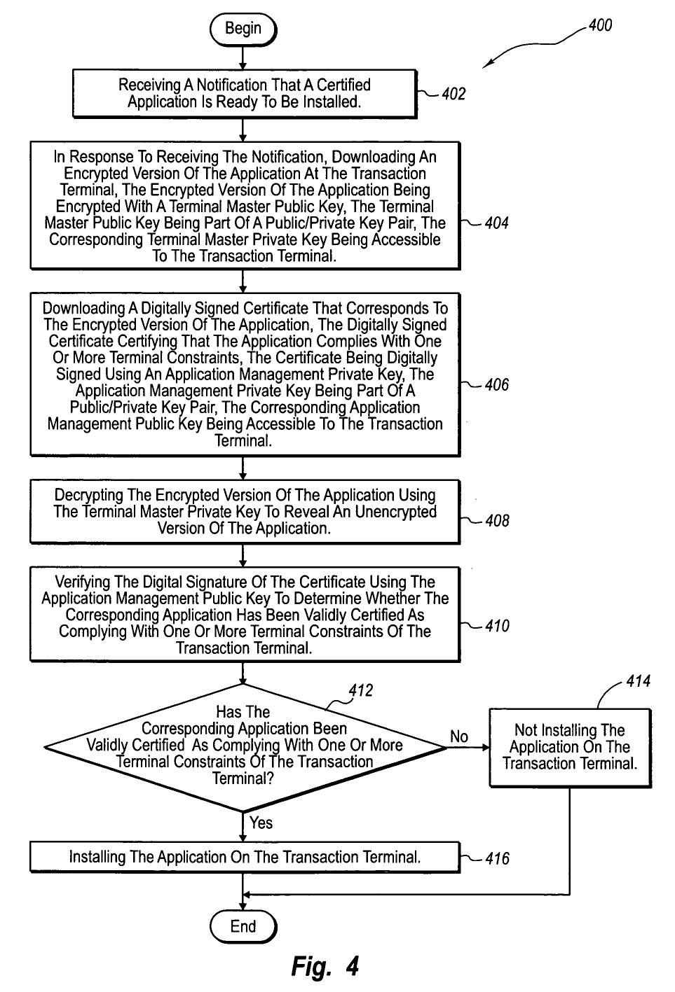

Turning now to FIG. 4, FIG. 4 depicts a method 400 for implementing features of the present invention. Method 400 is a method for validating a certified application for installation on a transaction terminal. Method 400 will be discussed with reference to the components and data in FIGS. 2A-2C.

Method 400 includes an act (402) of receiving a notification that a certified application is ready to be installed. For example, Transaction Terminal 210 can receive a notification that a certified application 318 is ready to be installed. This notification can either come from Terminal Key Management Server 204, Application Download Server 206, or another server that is configured to notify Transaction Terminal 210 that a certified application is ready to be downloaded.

Method 400 also includes an act (404), in response to receiving the notification, of downloading an encrypted version of the application at the transaction terminal, the encrypted version of the application being encrypted with a terminal master public key, the terminal master public key being part of a public/private key pair, the corresponding terminal master private key being accessible to the transaction terminal. For example, Transaction Terminal 210 can download an encrypted version of application 318 from Application Download Server 206. The encrypted version of application 318 was encrypted with a terminal master public key 330 which is part of a public/private key pair 328 and the corresponding terminal master private key 332 is accessible to the Transaction Terminal 210. For example, as described above, the terminal master public/private key pair 328 can be stored in the Key Storage 276 of the Embedded HSM 254.

Method 400 also includes an act (406) of downloading a digitally signed certificate that corresponds to the encrypted version of the application, the digitally signed certificate certifying that the application complies with one or more terminal constraints, the certificate being digitally signed using an application management private key, the application management private key being part of a public/private key pair, the corresponding application management public key being accessible to the transaction terminal. For example, Transaction Terminal 210 can download a digitally signed certificate 320 along with the encrypted version of application 318. The purpose of the digitally signed certificate 320 is to certify that application 318 complies with one or more terminal constraints of Transaction Terminal 210. Certificate 320 is digitally signed using an application management private key 324 which is part of a public/private key pair 322 and the corresponding application management public key 326 is accessible to Transaction Terminal 210.

Method 400 also includes an act (408) of decrypting the encrypted version of the application using the terminal master private key to reveal an unencrypted version of the application. For example, the Transaction Terminal 210 can decrypt the encrypted version of application 318. This is accomplished using terminal master private key 332 to reveal an unencrypted version of application 318. As discussed above, terminal master private key 332 can be stored in the Key Storage 276 of Embedded HSM 254, and the decryption of application 318 can be handled by the Crypto Processor 278 of Embedded HSM 254. Alternatively, terminal master private key 332 can be stored in another module of Transaction Terminal 210, and the decryption of the encrypted version of application 318 can be handled by the Cryptography module 248 of Transaction Terminal 210. The Security Manager module 262 can instigate the decryption of application 318.

Method 400 also includes an act (410) of verifying the digital signature of the certificate using the application management public key to determine whether the corresponding application has been validly certified as complying with one or more terminal constraints of the transaction terminal. For example, the Transaction Terminal 210 can verify certificate 320 using application management public key 326. As with the decryption of application 318 above, this verification of the digitally signed certificate 320 can be accomplished by the Crypto Processor 278 or, alternatively, by the Cryptography module 248. The Security Manager module 262 can instigate the verification of the digital signature of certificate 320.

By verifying certificate 320, the Security Manager module 262 is verifying that application 318 has been validly certified as complying with one or more terminal constraints of Transaction Terminal 210. The one or more terminal constraints were discussed above in connection with FIG. 3. As discussed above, the one or more terminal constraints can be specified in certificate 320. The one or more terminal constraints can include a maximum amount of hardware and software resources of Transaction Terminals 210 that application 318 can utilize after installation, or the security priority that application 318 will be assigned once installed. In one embodiment, the act 410 can also involve the Resource Manager module 276 determining whether the Transaction Terminal 210 has sufficient hardware and software resource available to support the maximum amount of hardware and software resources as specified in certificate 320.

Method 400 also includes a decision block (412) where the method branches one of two ways depending on whether the application has been validly certified as complying with one or more terminal constraints of the transaction terminal. If the application has not been validly certified as complying with one or more terminal constraints of the transaction terminal (not at 412), then method 400 proceeds to an act (414) of not installing the application on the transaction terminal. For example, if the Crypto Processor 278 of Embedded HSM 254 determines that certificate 320 has not been validly digitally signed, the corresponding application 320 will not be installed on Transaction Terminal 210.

If, on the other hand, the application has been validly certified as complying with one or more terminal constraints of the transaction terminal (yes at 412), then method 400 proceeds to an act (416) of installing the application on the transaction terminal. For example, if the Crypto Processor 278 of Embedded HSM 254 determines that certificate 320 has been validly digitally signed, and thus determines that the application 320 has been validly certified as complying with one or more terminal constraints of the transaction terminal, then application 318 will be installed on Transaction Terminal 210. The installation of application 320 can be handled by the Application Manager module 260. At the same time, the Application Manage module 260 will create an application profile for the application in which the terminal constraints specified in certificate 320 will be listed. Once application 318 is installed on Transaction Terminal 210, the Security Manager module 262 can constrain application 318 to the specific terminal constraints listed in the application profile, including hardware and software utilization constraints and security priority constraints.

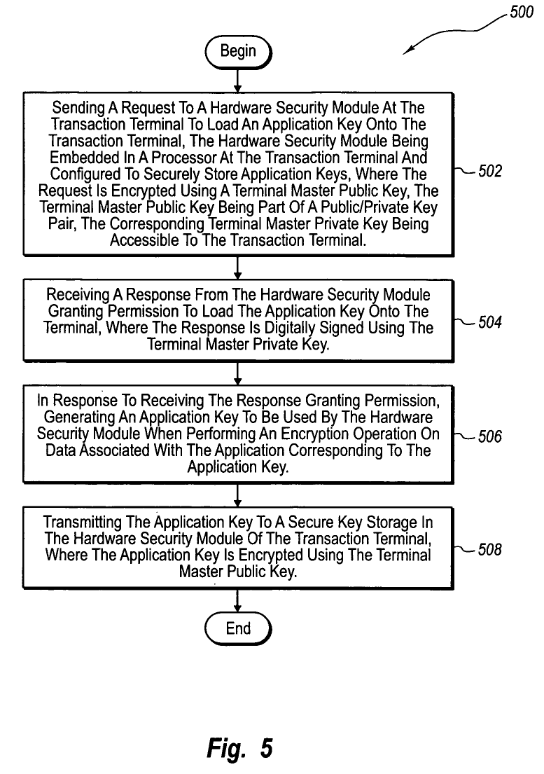

Turning now to FIG. 5, FIG. 5 depicts a method 500 for implementing features of the present invention is illustrated. Method 500 is a method for securely providing an application key to a transaction terminal. Method 500 will be discussed with reference to the components and data in FIGS. 2A-2C.

Method 500 includes an act (502) of sending a request to a hardware security module at the transaction terminal to load an application key onto the transaction terminal, the hardware security module being embedded in a processor at the transaction terminal and configured to securely store application keys, where the request is encrypted using a terminal master public key, the terminal master public key being part of a public/private key pair, the corresponding terminal master private key being accessible to the transaction terminal. For example, Application Key Management Server 230, which can act as a security access module delivery server, can send a request to Embedded HSM 254 of Transaction Terminal 210 to load onto the Transaction Terminal 210 an application key or application key pair for a specific application that is installed on Transaction Terminal 210. As discussed above, Embedded HSM 254 is embedded in a processor at the Transaction Terminal 210 and includes Key Storage 276 which is configured to securely store application keys and other keys. The request is encrypted using terminal master public key 330 which is part of a public/private key pair 328 and the corresponding terminal master private key 332 is accessible to the Transaction Terminal 210. In this case, terminal master private key 332 is accessible to the Transaction Terminal because terminal master private key 332 is stored in the Key Storage 276 of the Embedded HSM 254 of Transaction Terminal 210. However, terminal master private key 332 can be made accessible to Transaction Terminal 210 without being stored on Transaction Terminal 210.

The encrypted request is sent to Embedded HSM 254 of Transaction Terminal 210, as discussed above. This can be accomplished through the use of the Embedded SAM Manager module 264, which can receive the encrypted request and forward it to the Embedded HSM 254, where the Crypto Processor 278 can handle the decryption of the request using terminal master private key 332 stored in Key Storage 276.

The method 500 also includes an act (504) of receiving a response from the hardware security module granting permission to load the application key onto the terminal, where the response is digitally signed using the terminal master private key. For example, Application Key Management Server 208 can receive a response from Embedded HSM 254 granting permission to load the application key or application key pair onto the Transaction Terminal 210. The response is digitally signed by the Crypto Processor 278 using terminal master private key 332 that is stored in Key Storage 276, and then sent to Embedded SAM Manager module 264 where it is forwarded to Application Key Management Server 208.

Method 500 also includes an act (506), in response to receiving the response granting permission, of generating an application key to be used by the hardware security module when performing an encryption operation on data associated with the application corresponding to the application key. For example, in response to receiving the response granting permission, the Application Key Management Server 208 can generate the application key 334 to be used by Embedded HSM 254 when the Crypto Processor 278 of Embedded HSM 254 is performing an encryption operation on data associated with the application corresponding to the application key 334. Application key 334 can also be an application public/private key pair or other key that will be used by the application.

Method 500 also includes an act (508) of transmitting the application key to a secure key storage in the hardware security module of the transaction terminal, where the application key is encrypted using the terminal master public key. For example, Application Key Management Server 208 can transmit the application key 334 to Key Storage 276 in Embedded HSM 254. The application key 334 is encrypted using terminal master public key 330. The encrypted application key 334 is received by Embedded SAM Manager module 264 and forwarded to Embedded HSM 254. The key is decrypted by Crypto Processor 278 using the terminal master private key 332 stored in Key Storage 276. The key is then stored in Key Storage 276, which, as discussed above, is connected to Tamper Detect Circuit 274. Tamper Detect Circuit prevents the keys stored in Key Storage 276 from being accessed by an unauthorized intruder, as discussed above. Therefore, Key Storage 276 is a secure storage location for the application key 334 generated and transmitted in method 500.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a terminal key management server, a method for electronically certifying an application for installation at a transaction terminal, the method comprising:
an act of receiving an application along with a request to certify the application;
an act of comparing the application to one or more terminal constraints to determine whether the application complies with the one or more terminal constraints, where the one or more terminal constraints require at a minimum that the application will function properly in the operating environment on the transaction terminal;
if the application complies with the one or more terminal constraints, an act of issuing a certificate that corresponds to the application and certifies that the application complies with the one or more terminal constraints;
an act of digitally signing the certificate using an application management private key, the application management private key being part of a public/private key pair, the corresponding application management public key being accessible to the transaction terminal;
an act of encrypting the application using a terminal master public key, the terminal master public key being part of a public/private key pair, the corresponding terminal master private key being accessible to the transaction terminal; and
an act of making the digitally signed certificate and the encrypted application available to the transaction terminal.

2. The method as recited in claim 1, wherein the one or more terminal constraints are configurable by the owner of the transaction terminal.

3. The method as recited in claim 1, wherein the one or more terminal constraints are negotiated between the owner of the transaction terminal and the owner of the application.

4. The method as recited in claim 1, wherein the one or more terminal constraints specify the maximum amount of terminal hardware and software resources that the application can utilize.

5. The method as recited in claim 1, wherein the one or more terminal constraints specify the security priority of the application.

6. The method as recited in claim 1, wherein the certificate contains information about each of the one or more terminal constraints.

7. The method as recited in claim 1, wherein the act of making the digitally signed certificate and the encrypted application available to the transaction terminal comprises sending the certificate and encrypted application to a download server from which the transaction terminal can download the certificate and the encrypted application.

8. The method as recited in claim 1, wherein the application comprises a STIP application written in JAVA that has been translated into a JEFF file.

9. The method as recited in claim 1, wherein the application along with a request to certify the application are received in response to an electronic advertisement from the transaction terminal of available resource on the transaction terminal.

10. At a transaction terminal, a method for validating a certified application for installation on the transaction terminal, the method comprising:
an act of receiving a notification that a certified application is ready to be installed;
in response to receiving the notification, an act of downloading an encrypted version of the application at the transaction terminal, the encrypted version of the application being encrypted with a terminal master public key, the terminal master public key being part of a public/private key pair, the corresponding terminal master private key being accessible to the transaction terminal;
an act of downloading a digitally signed certificate that corresponds to the encrypted version of the application, the digitally signed certificate certifying that the application complies with one or more terminal constraints, the certificate being digitally signed using an application management private key, the application management private key being part of a public/private key pair, the corresponding application management public key being accessible to the transaction terminal;
an act of decrypting the encrypted version of the application using the terminal master private key to reveal an unencrypted version of the application;
an act of verifying the digital signature of the certificate using the application management public key to determine whether the corresponding application has been validly certified as complying with one or more terminal constraints of the transaction terminal; and
if the application has been validly certified, an act of installing the application on the transaction terminal.

11. The method as recited in claim 11, wherein the certificate specifies the one or more terminal constraints.

12. The method as recited in claim 11, wherein the one or more terminal constraints specify the maximum amount of hardware and software resources of the transaction terminal that the application can utilize.

13. The method as recited in claim 12, wherein an act of verifying the digital signature of the certificate using the application management public key to determine whether the corresponding application has been validly certified as complying with one or more terminal constraints of the transaction terminal further comprises determining whether the transaction terminal has sufficient hardware and software resources available to support the maximum amount of hardware and software resources as specified in the certificate.

14. The method as recited in claim 12, further comprising an act of constraining the application to utilizing the maximum amount of hardware and software resources specified in the certificate.

15. The method as recited in claim 11, wherein the one or more terminal constraints specify the security priority of the application.

16. The method as recited in claim 13, further comprising an act of constraining the application to the security priority specified in the certificate.

17. The method as recited in claim 1, wherein the application comprises a STIP application written in JAVA that has been translated into a JEFF file.

18. The method as recited in claim 1, wherein the operating environment on the transaction terminal comprises a platform that has been designed and specifically optimized for running STIP applications.

19. At a security access module delivery server, a method for securely providing an application key to a transaction terminal, the method comprising:
an act of sending a request to a hardware security module at the transaction terminal to load an application key onto the transaction terminal, the hardware security module being embedded in a processor at the transaction terminal and configured to securely store application keys, where the request is encrypted using a terminal master public key, the terminal master public key being part of a public/private key pair, the corresponding terminal master private key being accessible to the transaction terminal;
an act of receiving a response from the hardware security module granting permission to load the application key onto the terminal, where the response is digitally signed using the terminal master private key;
in response to receiving the response granting permission, an act of generating an application key to be used by the hardware security module when performing an encryption operation on data associated with the application corresponding to the application key;
an act of transmitting the application key to a secure key storage in the hardware security module of the transaction terminal, where the application key is encrypted using the terminal master public key.

20. The method as recited in claim 19, further comprising an act of encrypting data associated with the application using the application key, where the data associated with the application is being sent to the security access module delivery server.
